(19) United States
(12) Patent Application Publication
(10) Pub. No.: US 2008/0133760 A1
(43) Pub. Date: Jun. 5, 2008

(54) Method and Apparatus Allowing Remote Access in Data Networks

(76) Inventors: Winfried Antonius Henricus Berkvens, Eindhoven (NL); Mark Henricus Verberkt, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/533,714

(22) PCT Filed: Oct. 21, 2003
(86) PCT No.: PCT/IB03/04663

§ 371 Date: May 3, 2005

(30) Foreign Application Priority Data
Nov. 2, 2002 (EP) 02079679.3

(51) Int. Cl. G06F 15/16

(52) U.S. Cl. 709/228

(57) ABSTRACT

A method is provided for providing a possibility of starting a communication session from a public or global data network, such as the Internet, to a private or local data network, such as a residential home network, via a gateway device (18) connecting the public and the private network. The gateway device comprises a Network Address Translation (NAT) functionality, concealing for the public network the addressing realm of the private network, but also customarily blocking the starting of sessions from the public network. According to the method provided, a client device (10) connected to the public network can provide the possibility of starting a session to a server device (14) connected to the private network by performing an explicit remote access request directed toward the server device, involving the exchange of remote access request messages (20, 22) between the client, gateway, and server devices. At the server device, the request triggers a related remote access response directed at the client device, similarly involving the exchange of remote access response messages (24, 26) between the devices. As a result of these message exchanges, an appropriate NAT address binding can be established at the gateway device, allowing the subsequent starting of a session by the client device.

The invention relates to a method of providing a possibility of starting a communication session from a first device communicating via a first network to a second device connected to a second network, via an interface device connected between the first network and the second network, wherein the first network has a first addressing realm and the second network has a second addressing realm, and wherein the first device communicates via a first address in the first addressing realm, the second device has a second address in the second addressing realm, and the interface device has a third address in the first addressing realm.

The invention also relates to an interface device, a first device, a second device, and computer program products for performing said method.

The exponential growth of the Internet has led to a shortage of public Internet Protocol (IP) addresses to be used by different devices. The currently used version of IP, referred to as IP version 4 or IPv4, uses 32 bits to represent an IP address. The address space spanned by 32 bits has about 4.3 billion different addresses and this number of addresses is expected to become exhausted well before 2010. A known solution to the problem of IP address shortage is Network Address Translation (NAT). NAT is basically a one-to-one or a many-to-one IP address translation and operates in a router or a gateway interface device that is located between a local network and a global network. The local network is also referred to as the inside or the private network and the global network as the outside or the public network. NAT helps to preserve a limited number of public or global IP addresses through address reuse, by allowing that IP addresses for the local network can be reused across other local networks. Therefore, with NAT, the IP addresses used within the local network, for addressing devices connected to this network, are no longer required to be unique.

Apart from using the basic Internet Protocol, these types of networks use higher level protocols to allow peer entities on a source and a destination device to carry on a “conversation”. The source device or entity is also referred to as the client and the destination device or entity as the server. Two important higher level protocols are the Transmission Control Protocol (TCP) and the User Datagram Protocol (UDP). Besides using IP addresses for addressing devices, these higher level protocols also use port numbers, represented as 16-bit integers, to designate a starting point and an end point for data packets pertaining to a peer-to-peer interaction. A particular version of NAT, termed Network Address Port Translation (NAPT), extends the notion of address translation by also translating port numbers between a local and a global network addressing realm. NAPT is therefore a method by which a set of local network IP addresses and related TCP/UDP port numbers are translated into a single global network IP address and related TCP/UDP port numbers. As a result, NAPT allows a set of local devices to share a single global address. Nowadays, in an increasing number of homes and small offices, users have multiple networked devices, but only a single public IP address assigned to their public access gateway by their Internet service provider. These users very often use NAPT to allow multiple devices in their local network to simultaneously access the public network using the single IP address assigned to their gateway.

In NAT and NAPT, the address and port translations to be performed require a binding between local addresses and ports, on the one hand, and global addresses and ports, on the other hand. Such a binding is established whenever a communication session is started from within the local network toward the global network. Starting a session in the opposite direction, from the global network to the local network, is a problem however, because for such a session the local address and port information is not known at the start of the session, when an address and port binding must be made. At the same time, the ability to have this type of session becomes increasingly more desirable, for example, because of Internet-based game playing, video and audio streaming, and peer-to-peer networking in general.

A method of starting sessions from a global network to a device connected to a local network is known from RFC 2694, “DNS extensions to Network Address Translators (DNS_ALG)”, by P. Srisuresh, et al., September 1999. Here, a gateway is situated as an interface device between the local network and the global network. The gateway includes a NAT functionality and has a number of global IP addresses reserved. The local network includes a Domain Name Service (DNS) server, for translating local network domain and device names into IP addresses, and vice versa. The gateway also includes a DNS Application Level Gateway (DNS_ALG) functionality, for forwarding DNS name queries from the global network to the local network, and resulting DNS responses in the opposite direction. When a device connected to the global network wants to start a session with a device connected to the local network, it issues a DNS name query containing the name of the local device. This query reaches the gateway, and the gateway forwards the query to the DNS server. The DNS server resolves the query and returns a local address of the local device to the gateway. The gateway binds one of its global addresses to the local address and returns the global address as an answer to the query. The device connected to the global network can then start a session, using the received global address, and the gateway immediately knows for which local device this communication is intended because of the binding. However, there are some problems with this solution, due to the fact that a separate global address is required for each local device that has inbound sessions. For simultaneous sessions to multiple local devices, there have to be as many global addresses available for the gateway as there are local devices involved. This conflicts with one of the goals of NAT, namely preserving global addresses. Furthermore, if the local network has only one global address assigned, as is the case for NAPT, this one address will be tied up to a local device with the first inbound session started, without a possibility for additional inbound sessions to other devices.

It is an object of the invention to provide a method of providing a possibility of starting a communication session of the kind set forth in the first paragraph, which makes it possible to have simultaneous communication sessions from multiple devices communicating via a first network to devices connected to a second network, while the method requires only a single address for the second network in the addressing realm of the first network. This object is realized in that the method comprises the following steps:

the interface device receives a request from the first device to provide the possibility of starting the session, the request including a designation of the second device and a session specification,

determining a response for providing the possibility of starting the session,

the interface device establishes a binding for starting the session, the binding comprising binding the first address to the second address for the session specified, and

the interface device adapts the response to include the third address and sends the response to the first device.

What happens in these steps is that, prior to actually starting a communication session, the first device first sends a separate remote access request to the interface device, asking the interface device to create an address binding for accessing the second device remotely, that is from outside the second network. After receiving the remote access request, the interface device processes the request, which involves determining a remote access response, which is to be returned to the first device, and establishing an address binding. The address binding created by the interface device comprises the address of the first device, the address of the second device, and details pertaining to the communication session desired, like, for example, port numbers for the session to be started. The address of the first device, corresponding to the first address in the method, is implicitly known from the remote access request, since the request was sent by the first device. The address of the second device, corresponding to the second address in the method, is to be retrieved via the designation of the second device contained in the request. If, for example, this designation is the DNS name of the second device, a DNS server located in the second network can be used to retrieve the corresponding address. After the binding has been created, the interface device sends the remote access response toward the first device, thereby informing the first device of the fact that a binding has now been created and that the communication session can be started. Included in the response is the address of the interface device in the first network, which is the third address in the method. After receiving the response, the first device can start the session via this third address. Besides the first device other devices communicating via the first network can also perform a remote access request toward a device connected to the second network. These requests will be processed in essentially the same way and will result in similar bindings. By introducing an explicit remote access protocol, comprising remote access requests and responses, the invention allows having simultaneous communication sessions from devices communicating in the first network to devices connected to the second network.

The measure as defined in claim 2 has the advantage that, besides the interface device, also the second device itself is involved in the processing of a remote access request and the preparation of a remote access response. This, for example, allows the second device to perform a device specific processing of the remote access request or to prepare itself for the session to be started.

The measure as defined in claim 3 has the advantage that, if the second device does not support the remote access protocol according to the invention, the interface device by itself may still be able to completely process a remote access request for the second device.

The measure as defined in claim 4 has the advantage that a pair of port numbers, included in the session specification of a remote access request, is fully determined by the first device and can be readily used in the establishment of a binding. A first port number of the pair refers to the port on which the first device intends to start the session. The second port number refers to a service, like, for example, a HTTP service, that is expected to be available from the second device. It will be clear to those skilled in the art that a session specification need not be limited to a single pair of port numbers, and may instead comprise multiple pairs of port numbers and that for each of these a binding can be established. In addition, many more types of session specifications are possible, like, for example, the type comprising ranges of port numbers.

The measure as defined in claim 5 has the advantage that an explicit port number referring to a service expected to be available from the second device is not required and therefore need not be known initially to the first device. Instead, the service itself, like, for example, a HTTP service, is designated in a session specification, and the second device or the interface device then determines a port number corresponding to this service. This port number is included in the remote access response for use by the first device when starting a session. It will be clear to those skilled in the art that a session specification need not be limited to a single combination of a port number and a service designation, and may instead comprise a multiple of such combinations and that for each of these a binding can be established. In addition, many more types of such session specifications are possible.

Another method of starting sessions from a global network to a device connected to a local network is known from RFC 3022, “Traditional IP Network Address Translator (Traditional NAT)”, by P. Srisuresh and K. Egevang, January 2001. Here, inbound sessions may be allowed on an exceptional basis by the gateway device using static bindings for pre-selected devices connected to the local network. A static binding binds a global port of the gateway device to a pre-defined local IP address and port number of a local device. This allows starting one or more sessions via the global port of the gateway to the pre-selected local device. However, having to pre-select a local device is generally considered to be a disadvantage of this method. Furthermore, by nature, static bindings are not very adaptable to changes in the configuration of the local network, for example, because of a device being added or removed. In addition, static bindings customarily also require the assistance of an expert in the area of networking for their setup or modification.

A further method is known from WO-0215014. Here, a device connected to a global network receives the global address of a gateway for a local network via a DNS server and then contacts the gateway. The gateway returns a local address of the device to be contacted in the local network. The device connected to the global network can then start a session by communicating with the gateway, using both the global address and the local address. This method requires modifications of the TCP and UDP protocols to accommodate for the exchange of both the global address and the local address between the device starting the communication session and the gateway.

An interface device according to the invention is defined in claim 6.

A first device according to the invention is defined in claim 9.

A second device according to the invention is defined in claim 10.

Computer program products according to the invention are defined in claims 11, 12, and 13.

The invention will be further elucidated and described with reference to the drawings, in which:

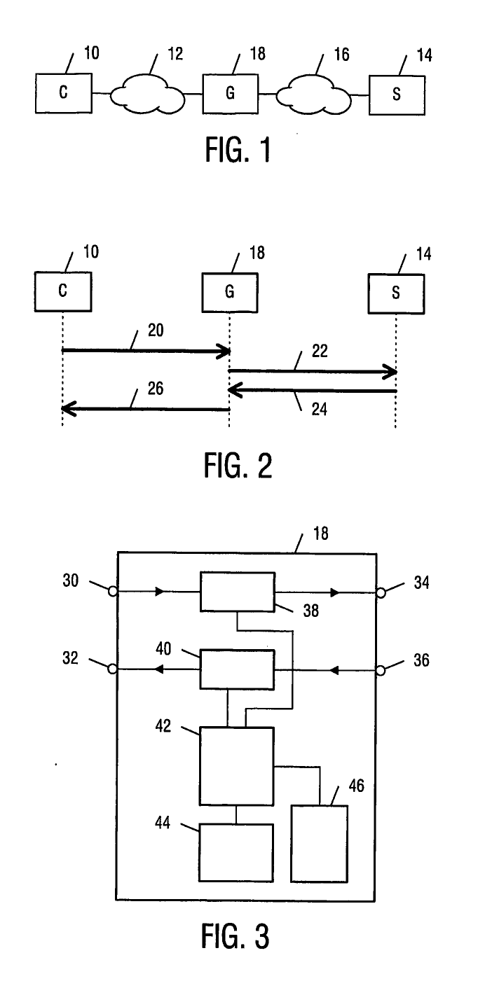

FIG. 1 shows a schematic drawing of a first (client) device connected to a public network and a second (server) device connected to a private network with the two networks connected via an interface (gateway) device according to the invention;

FIG. 2 shows a message sequence chart that illustrates in a schematic way the exchange between these client, gateway, and server devices of remote access request and response messages of the method according to the invention;

FIG. 3 shows a block diagram of a simplified version of a gateway device according to the invention;

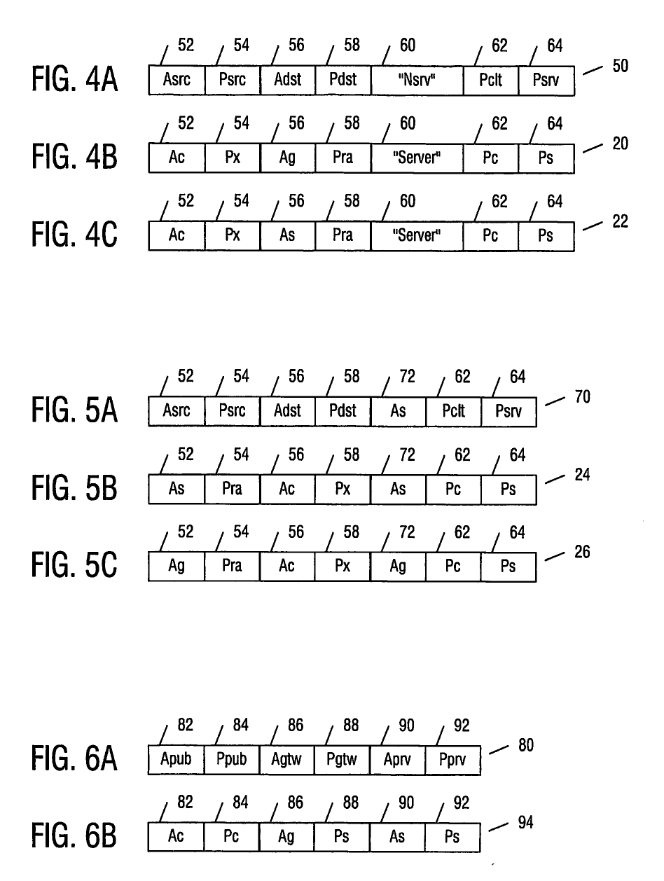

FIG. 4A shows in a schematic way the contents of a remote access request message in general;

FIG. 4B shows in a schematic way the contents of the remote access request message as exchanged between the client device and the gateway device;

FIG. 4C shows in a schematic way the contents of the remote access request message as exchanged between the gateway device and the server device;

FIG. 5A shows in a schematic way the contents of a remote access response message in general;

FIG. 5B shows in a schematic way the contents of the remote access response message as exchanged between the server device and the gateway device;

FIG. 5C shows in a schematic way the contents of the remote access response message as exchanged between the gateway device and the client device;

FIG. 6A shows in a schematic way the contents of an entry in a binding table of the gateway device in general;

FIG. 6B shows in a schematic way the contents of an entry in a binding table of the gateway device as established after the possibility of starting a session has been provided between the client, gateway, and server devices;

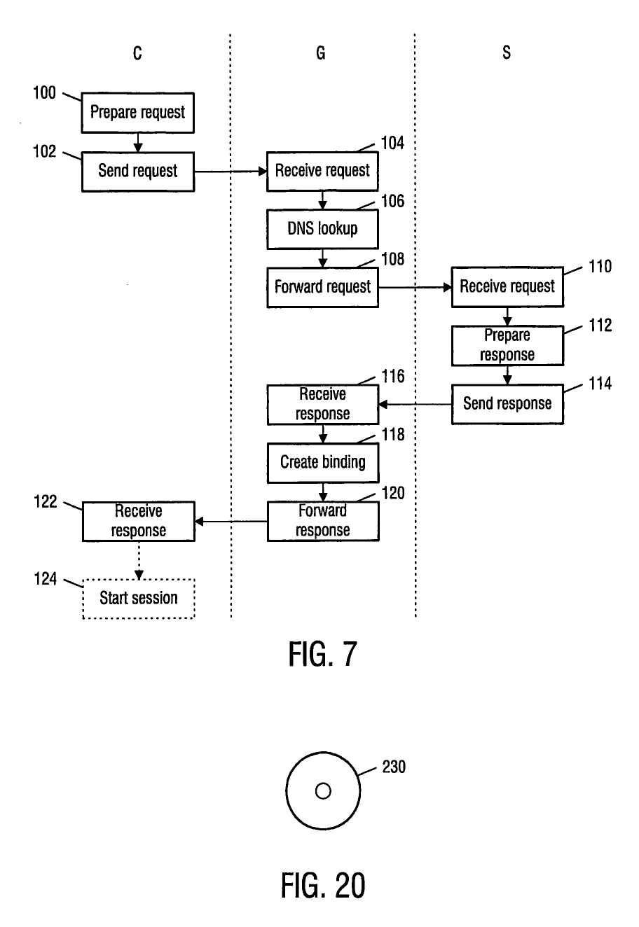

FIG. 7 shows a flow chart that illustrates in a schematic way the processing steps at the client, gateway, and server devices for an embodiment of the method according to the invention;

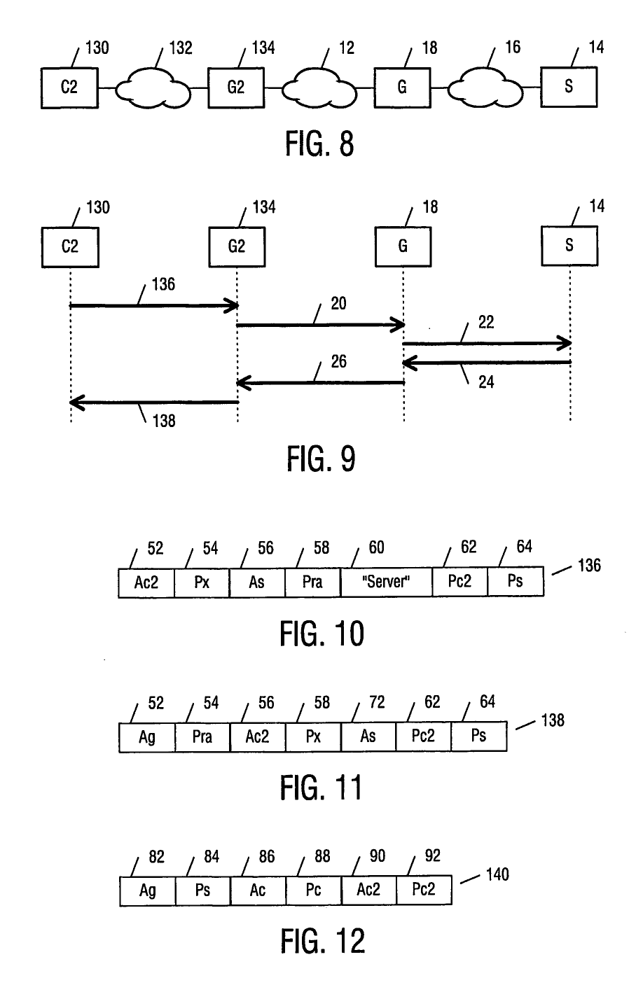

FIG. 8 shows a schematic drawing of a client and a server device connected to respective private networks and these two networks in turn connected to a public network via respective gateway devices;

FIG. 9 shows a message sequence chart that illustrates in a schematic way the exchange between these client, gateway, and server devices of remote access request and response messages of the method according to the invention;

FIG. 10 shows in a schematic way the contents of an additional remote access request message;

FIG. 11 shows in a schematic way the contents of an additional remote access response message;

FIG. 12 shows in a schematic way the contents of an additional binding table entry;

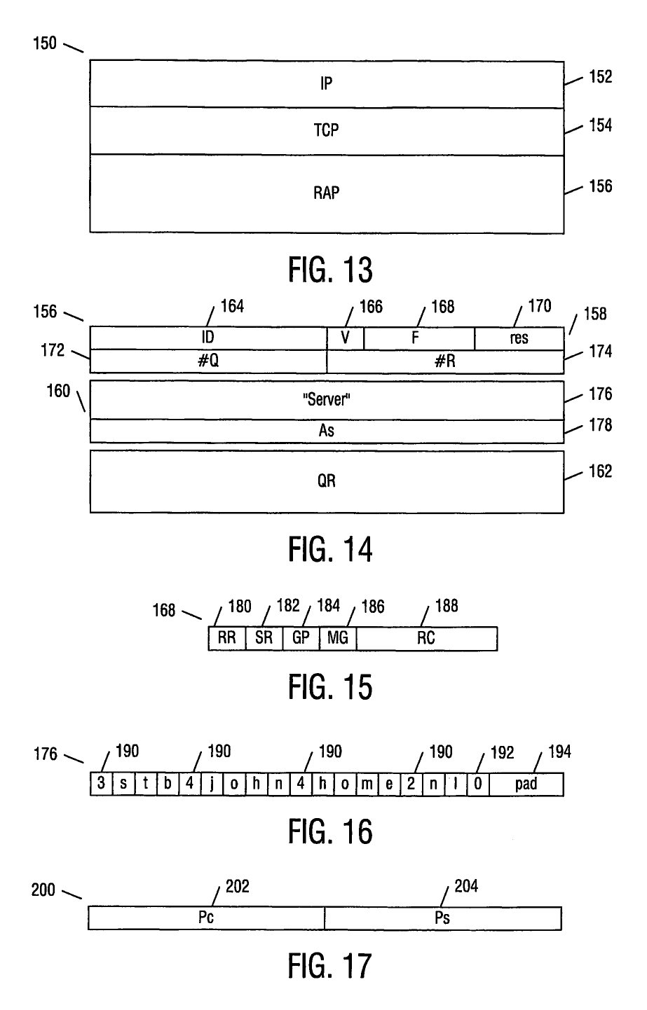

FIG. 13 shows in a schematic way, for an embodiment of the method according to the invention, the overall format of an IP data packet for a remote access message;

FIG. 14 shows in a schematic way the general format of the remote access message;

FIG. 15 shows in a schematic way the format of a flag field of the remote access message;

FIG. 16 shows in a schematic way the format of a server name field of the remote access message;

FIG. 17 shows in a schematic way the format of a port number pair field of the remote access message;

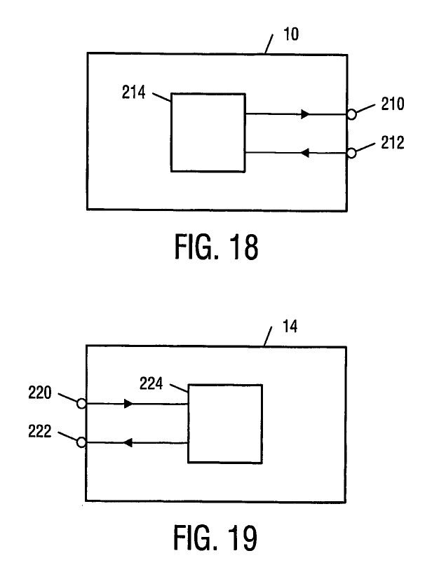

FIG. 18 shows a block diagram of a simplified version of a client device according to the invention;

FIG. 19 shows a block diagram of a simplified version of a server device according to the invention;

FIG. 20 shows a schematic drawing of a computer readable medium on which a computer program code is stored for performing the method according to the invention.

FIG. 1 shows a schematic drawing of an embodiment according to the invention and its environment. The Figure shows a client device 10 connected to a public network 12 and a server device 14 connected to a private network 16, with the two networks connected via a gateway device 18 according to the invention. The gateway device 18 includes a NAPT address translation function between the private network 16 and the public network 12, concealing the server device 14 from the public network and beyond. In this configuration, the client device 10 wishes to start a communication session with the server device 14. In terms of the invention, the client device 10 corresponds to the first device, the public network 12 corresponds to the first network, the server device 14 corresponds to the second device, the private network 16 corresponds to the second network, and the gateway device 18 corresponds to the interface device. The public network 12 has a first addressing realm and the private network 16 has a second addressing realm. Both addressing realms are here IP addressing realms, for example, IPv4. The first addressing realm is used globally, while the second addressing realm is a local addressing realm used inside the private network 16. In a preferred embodiment, the public network 12 is the Internet and the private network 16 is a private home network. It should, however, be noted that the invention is not limited to private home networks, but can also be used in, for example, small office or corporate networks. The client device 10 is also denoted as C, the server device 14 as S, and the gateway device 18 as G. The different devices thus have different addresses in the different addressing realms. The client device 10 has a first address Ac in the addressing realm of the public network 12, the gateway device 18 has a third address Ag in the addressing realm of the public network 12, and the server device 14 has a second address As in the addressing realm of the private network 16. It is to be noted that the gateway device 18 also has an address in the addressing realm of the private network 16. However, this is not further described here, because this address is not an essential part of the invention. The server device 14 may be a regular computer, but is not limited to this. It may be some other computational device as well, such as a peer-to-peer audio or video server, a printer, a scanner or any other type of computer equipment which can be connected in computer networks using an address. It is to be realized that normally there are several more devices connected to the second network 16. It is also to be realized that the client device 10 may be a device on a private or local network communicating with the global network 12 via a gateway. This is also described in more detail below. The client device 10 is shown here as a device connected directly to the public network 12 in order to better explain the invention.

FIG. 2 shows a message sequence chart that illustrates in a schematic way the exchange of a remote access request and a remote access response between the client, gateway, and server devices over time. Before the client device 10 can start a communication session with the server device 14, the client device 10 first provides a possibility of starting the session by way of the method according to the invention. The client device 10 therefore prepares a remote access request and sends it as a remote access request message 20 toward the server device 14. Here the remote access request message 20 is first received by the gateway device 18, however. After receiving the message 20, the gateway device 18 starts processing this request, which includes forwarding the request as a remote access request message 22 toward the server device 14. After receiving the message 22, the server device 14 processes the request and prepares a remote access response, which it returns as a remote access response 24 to the gateway device 18. After receiving the message 24, the gateway device 18 completes processing the remote access request, which includes creating a binding for the session to be started and the forwarding of the response as a remote access response message 26 to the client device. After receiving the response message 26, the client device 10 can start the communication session (not shown), based on results obtained with response message 26. It is to be noted that a client device and a server device may be both connected to the same network and still use the remote access protocol to provide the possibility of starting a session. However, this is not further described here, because this no longer involves the use of a gateway device with a NAT/NAPT address translation function.

FIG. 3 shows a block diagram of a simplified version of the gateway device 18. The gateway device 18 has a first input 30 connected to the public network 12 for receiving data packets, such as, for example, the remote access request message 20, and a first output 32 also connected to the public network 12 for sending data packets, such as, for example, the remote access response 26. The gateway device 18 also has a second output 34 connected to the private network 16 for sending data packets, such as, for example, the remote access request message 22, and a second input 36 also connected to the private network 16 for receiving data packets, such as, for example, the remote access response 24. A first register 38 is connected between the first input 30 and the second output 34, while a second register 40 is connected between the second input 36 and the first output 32. The directions in which the data packets travel are indicated with arrows. The first and second registers 38 and 40 are both connected to a control unit 42, which control unit 42 is connected to a binding table 44 and to a name resolving unit 46. A binding table is a table containing address bindings for communication sessions. The name resolving unit 46 is a DNS server that maps a domain name to an address, and here to an address in the addressing realm of the private network 16.

FIG. 4A shows the contents of a remote access request message 50 in general. Like most other IP-based messages, the remote access request message 50 contains address information related to a source and a destination address. The source address information refers to the sender of the message and includes an IP address field 52 and a port number field 54. Likewise, the destination address information refers to the intended recipient of the message, and also includes an IP address field 56 and a port number field 58. Besides this common IP address information, the remote access request message 50 contains message type specific data, commonly referred to as the payload of a message. For the remote access request message 50, the payload includes a domain name field 60 for the name of a server device to which a session is to be started, and a session specification comprising a pair of port number fields 62 and 64. Port number field 62 refers to the port number that will be used by the client device, and port number field 64 refers to the port number that will be used by the server device. FIG. 4B shows the contents of the remote access request message 20 of FIG. 2, as exchanged between the client device 10 and the gateway device 18. Likewise, FIG. 4C shows the contents of the remote access request message 22, as exchanged between the gateway device 18 and the server device 14. FIGS. 4B and 4C are described in more detail below.

FIG. 5A shows the contents of a remote access response message 70 in general. Equal to the remote access request message 50 of FIG. 4A, the remote access response message 70 contains address information related to a source and a destination address. The payload of the remote access response message 70 includes an IP address field 72 for addressing the server device to which a session is to be started, and the session specification that is also present in the remote access request message 50. FIG. 5B shows the contents of the remote access response message 24 in FIG. 2, as exchanged between the server device 14 and the gateway device 18. Likewise, FIG. 5C shows the contents of the remote access response message 26, as exchanged between the gateway device 18 and the client device 10. FIGS. 5B and 5C are described in more detail below.

FIG. 6A shows in a schematic way the contents of an entry 80 in the binding table 44 of the gateway device 18. Each entry in the binding table 44 is dedicated to an ongoing session or to a session for which the possibility of starting it has just been provided by means of a remote access request. For simplicity, only individual entries are shown here, although it is to be realized that there can be several entries for sessions between different devices and also several entries for different sessions between the same two devices. It is also to be realized that, for a session specification that is not limited to a single pair of port numbers, there can even be several entries for a single session. FIG. 6A shows the contents of an entry 80 in general. In each entry, there are three IP address and port number combinations. A first column 82 is intended for the addresses of devices connected to the public network 12, while a second column 84 is intended for the port numbers related to these addresses of the public network 12. A third column 86 is intended for the addresses of the gateway device 18 in the addressing realm of the public network 12. For a NAPT translation function, there will only be one such address and therefore the contents of this column will then always be the same. A fourth column 88 is intended for the port numbers related to the address or the addresses of the gateway device 18. A fifth column 90 is intended for the addresses of devices in the private network 16, while a sixth column 92 is intended for the port numbers related to these addresses of the private network 16. FIG. 6B shows an entry 94 as established after the possibility of starting a session has been provided between the client device 10, the gateway device 18, and the server device 14. This entry is described in more detail below.

FIG. 7 shows a flow chart that illustrates in a schematic way the processing steps at the client device 10, the gateway device 18, and the server device 14 for an embodiment of the method according to the invention. The processing steps will be discussed together with the contents of the related remote access messages 20, 22, 24, and 26 of FIGS. 2, 4B, 4C, 5B, and 5C as well as the binding table entry 94 of FIG. 6B. Processing starts in a situation in which the client device 10 wants to start a communication session with server device 14. To provide the possibility of starting this session, the client device 10 uses a remote access request and therefore prepares a remote access request message 20, in step 100. Since the client device 10 acts as the source and sender of the message 20, the source address information in the message 20 includes the address Ac of the client device 10 in field 52 and a port number Px in field 54. The port number Px identifies the port on which the client device 10 expects to receive a remote access response for this remote access request. The destination address information in the message 20 includes the address Ag of the gateway device 18 in field 56 and a port number Pra in field 58. The port number Pra is a well-known port number that has been reserved in advance for use with the remote access protocol for receiving remote access request messages. Devices supporting the remote access protocol are required to listen on port Pra for incoming remote access request messages from other devices. Considering the foregoing in some more detail, the following can be added. Before the client device 10 can prepare and send a remote access request message for providing the possibility of starting a session, it first has to know an address via which to reach the server device. The normal procedure that can be used for this is that the client device 10 performs a DNS name query for the server device 14. In this case, the DNS name of the server device 14 is ultimately sent to a DNS server situated in the second network. Here this will be the DNS server 46 included in the gateway device 18. This DNS server returns a DNS response containing the address belonging to the DNS name. Initially, this will be the address As of the server device in the addressing realm of the private network 16. However, as the gateway device 18, comprising a NAPT translation function, is situated in the path between the client device 10 and the DNS server 46, and conceals the server device 14, the address contained in the DNS response as returned to the client device 10 will be the address Ag of the gateway device 18. This address substitution in the DNS response is performed by a DNS_ALG function in the gateway device 18. Besides using a DNS name query, other ways for obtaining the address via which to reach the server device may also be used.

Returning to the preparation of the remote access request message 20 in step 100, the client device 10 also adds the payload to the message, here the domain name of the private device 14, symbolically indicated by “Server”, in the name field 60, plus the port number Pc that will be used by the client device 10 for the session, in the port number field 62, and the port number Ps that will be used by the server device 14 for the session, in the port number field 64. Thereafter, the client device 10 sends the remote access request message 20 to the gateway device 18, in step 102.

After receiving the remote access request message 20, in step 104, the gateway device 18 starts processing this request, which includes forwarding the request as a remote access request message 22 toward the server device 14. To do this, the gateway device 18 modifies the remote access request message as received by changing the destination address information in the address field 56 from Ag to As, the address of the server device 14. The address As can be determined by the gateway device 18 by performing a local DNS name lookup, in step 106, via the DNS server 46 using the server name included in the name field 60 of the message 20. The modified remote access request can then be forwarded as the message 22 to the server device.

Upon receiving the remote access request message 22, in step 110, the server device 14 processes the request. This mainly involves the preparation, in step 112, and sending, in step 114, of a remote access response message 24. Since the server device 14 now acts as the source and sender of the response message 24, the source address information in the message 24 includes the address As of the server device in address field 52 and the port number Pra in the port number field 54, also corresponding to the destination address information in the request message 22. The destination address information for the response message 24 is taken from the source address information in the request message 22, namely the address Ac and the port number Px of the client device. Furthermore, in the payload of the response message 24, the address As of the server device is now included, in the address field 72, as well as the session specification, in the port number fields 62 and 64, taken from the corresponding fields of the request message 22. The response message 24 is then sent to the gateway device, in step 114, which is to perform the routing to the client device 10.

At the gateway device 18, after receiving the remote access response message 24, in step 116, a binding for the session to be started is created, in step 118, using the information contained in the response message 24. The binding table entry 94 created contains the address Ac and the port number Pc of the client device 10 in the public network fields 82 and 84, respectively. The gateway-related public network fields 86 and 88 are filled with the address Ag of the gateway device 18 and the port number Ps, respectively. The private network-related fields 90 and 92 are filled with the address As of the server device 14 and the port number Ps as well. As a result, a subsequent session started by the client device 10, using the address Ac and the port number Pc and directed to the address Ag and the port number Ps of the gateway device 18 will be routed by the NAPT address translation function to the address As and the port number Ps of the server device 14. After creating the binding, the gateway device 18 can forward the remote access response toward the client device 10. As part of this operation, the response message is modified by replacing the private network address As in the source address field 52 and in the server address field 72 in the payload part of the response message with the public network address Ag of the gateway device 18. The resulting remote access response message 26 can then be forwarded to the client device 10, in step 120.

After receiving the remote access response message 26, in step 122, the client device 10 can start the communication session, in step 124. For this session, the client device 10 will then use the destination address Ag, obtained from the server address field 72 of the remote access response message 26, and the destination port number Ps, obtained from the server device port number field 64 of the remote access response message 26. The client device 10 will furthermore use the source address Ac, and the source port number Pc.

In a possible further extension for this embodiment (not shown), the gateway device 18 may fully prepare the remote access response message 26, without first requiring the remote access response message 24 to be received from the server device 14. This may be used by the gateway device 18 in a situation where the server device 14 does not support the remote access protocol, and does not itself prepare and send a response message 24. After not receiving a response message 24 from the server device 14 within a predetermined time interval after sending the remote access request message 22, the gateway device 18 now prepares the response message 26 by itself.

As already indicated, a client device may itself also be a device on a private network. This is schematically shown in FIG. 8, where a client device 130 is connected to a private network 132, with the private network 132 connected via a gateway device 134 to the public network 12. The client device 130 is also denoted as C2 and the gateway device 134 as G2. The gateway device 134 is very similar to the gateway device 18 in that it also includes a NAPT address translation function and support for the remote access protocol. Also, the gateway device 134 conceals the client device 130 for the public network 12 and beyond, just like the gateway device 18 does this for the server device 14. Given that now the gateway device 134 instead of the client device 10 uses the address Ac and the port number Pc in the addressing realm of the public network 12, this also means that nothing has changed for the gateway device 18 and the server device 14 with respect to the handling of remote access requests and responses as described above.

FIG. 9 now shows, similarly to FIG. 2, a corresponding message sequence chart that illustrates in a schematic way the exchange of a remote access request and a remote access response between the client, gateway, and server devices over time. Here the client device 130 prepares a remote access request and sends it as a remote access request message 136 toward the server device 14. However, before arriving at server device 14, the request is first received and processed by the gateway device 134, giving rise to the forwarding of a remote access request message 20, which is in turn received and processed by the gateway device 18, resulting in the forwarding of a remote access request message 22. After receiving the request message 22, the server device 14 processes the request, and prepares a remote access response, which it returns as a remote access response 24 to the gateway device 18. From there, the response is forwarded first to the gateway device 134, as a response message 26, and from there to the client device 130, as a response message 138. After receiving the response message 138, the client device 130 can start the communication session (not shown). Since here the gateway device 134 is merely a forwarding device, and not an endpoint in the remote access protocol, the associated processing of the remote access request and the related response is very much along the lines of the well-known NAPT processing, involving changes to IP addresses and port numbers. An exception in this respect is the adaptation of the client device port number in the port number field 62 in the payload part of the remote access request and response messages 136, 20, 26, and 138. Given that the client device furthermore has an address Ac2 in the addressing realm of the private network 132 and wants to use a port number Pc2 for the session to be started, the messages 136 and 138 will contain the port number Pc2 in the port number field 62. The gateway device 134 must now map the port number Pc2 to the port number Pc and vice-versa in the remote access messages. The port numbers Pc2 and Pc are also part of a binding table entry for the session to be started in the gateway device 134.

FIG. 10 shows in a schematic way the contents of the remote access request message 136 of FIG. 9. Similarly, FIG. 11 shows the contents of the remote access response message 138 of FIG. 9. FIG. 12 shows in a schematic way the contents of a binding table entry 140 in a binding table 44 of the gateway device 134 as it is established after the possibility of starting a session has been provided via the remote access protocol.

It will be clear to those skilled in the art that a further extension which involves more than two gateway devices between a client device and a server device is also possible. Such a case involves local networks and corresponding addressing realms that are embedded in other local networks, either with respect to the client device, the server device, or both devices. For gateway devices situated between the client device and the public network, the required processing is then essentially as described above for the gateway device 134. For gateway devices situated between the server device and the public network, the required processing is then essentially as described above for the gateway device 18. It will also be clear to those skilled in the art that in another extension the client session specification need not be limited to a single pair of port numbers, and may instead comprise multiple pairs of port numbers and that for each of these a binding can be established. Other types of session specifications are possible too, for example, specifications comprising ranges of port numbers.

FIGS. 13 to 17 show in a schematic way several aspects of the remote access request and response message formats for a further embodiment of the method according to the invention. FIG. 13 shows the overall format of an IP data packet 150 for a remote access message. The data packet 150 has a 20-byte IP header 152, a 20-byte TCP header 154, and a variable-length remote access message section 156. The IP header 152 comprises a source and a destination IP address (not shown), and the TCP header 156 comprises a source and a destination port number (not shown). Details of the IP header 152 and the TCP header 154 formats can be found in, for example, “TCP/IP Illustrated, Volume 1—The Protocols”, by W. Stevens, 1994.

FIG. 14 shows the general format of the remote access message section 156. The message section 156 has a fixed 8-byte header part 158 followed by two variable-length parts 160 and 162. The header part 158 has a 2-byte identification field 164, a 2-bit version field 166, an 8-bit flag field 168, a 6-bit reserved field 170, a 2-byte number of queries field 172, and a 2-byte number of replies field 174. The value of the identification field 164 is set by a client device and returned by a server device, and allows the client device to match remote access responses to remote access requests. The version field 166 contains a value of 1 for this particular version of the remote access protocol. The flag field 168 is described below. To fill the header part up until the first 32-bit boundary, the reserved field 170 has been added, containing all zeros. This field can be used for future extensions. The number of queries field 172 is filled with a value for the number of session access queries (see below) in case of a remote access request message and with a value of 0 in case of a remote access response message. Similarly, the number of replies field 174 is filled with a value of 0 in case of a remote access request message and with a value for the number of session access replies (see below) in case of a remote access response message. For the current version of the remote access protocol, the session access queries and replies always refer to port number pairs. Also, the number of session access queries in a request message will equal the number of session access replies in the related response message. A number of queries field 172 containing a value higher than one can be used for providing the possibility of starting a session with the specified multiplicity of port number pairs between the client device and the server device. Alternatively, a corresponding number of individual session access queries can be made via separate remote access requests.

FIG. 15 shows the format of the flag field 168. This field is further divided into five parts: a 1-bit request/response field 180, a 1-bit server response field 182, a 1-bit gateway present field 184, a 1-bit multiple gateways present field 186, and a 4-bit return code field 188. The request/response field 180 indicates whether the message is a remote access request, with a value of 0, or a response, with a value of 1. The three subsequent fields 182-186 are only relevant in case of a remote access response message. A value of 0 in the server response field 182 indicates that an intermediate gateway device instead of the server device (as given in the server name field 176 of the message, see below) is responding. A value of 1 indicates that the response originates from the server device. In principle, a request is always intended for the server device, but if this server device does not implement the remote access protocol, the gateway device serving the network to which the server device is connected may instead return a response message after a predetermined timed-out period. Thus it is guaranteed that a response is sent back to the client device in a reasonable time. A value of 0 in the gateway present field 184 indicates that there is no gateway device present on the path between the client device and the server device. A value of 1 indicates that there is at least one gateway device present on the path. A value of 0 in the multiple gateways present field 186 indicates that there is no or only a single gateway device present on the path between the client device and the server device. A value of 1 indicates that there are multiple gateway devices present on the path. The purpose of these fields is to obtain some more information about the path that is followed by the messages. A value of 0 in the return code field 188 indicates that there has not been an error in the processing of the message. Other return code values can be added later on, if needed.

Returning to FIG. 14, the first variable-length part 160 of the remote access message section 156 consists of a variable-length server name field 176 and a 4-byte server IP address field 178. The server name field 176 uses the same format as a domain name in a DNS query message, as described in, for example, the “TCP/IP Illustrated” reference mentioned above. A sample for a server name field 176 is shown in FIG. 16. This field comprises a sequence of one or more labels, where each label begins with a 1-byte count field 190, specifying the number of 1-byte characters that follow. The server name field 176 is terminated with a 1-byte terminator field 192, which contains a value of 0, and which indicates the root of the server name. The value in each count field 190 must be in the range of 0 to 63, as labels are limited to 63 bytes. To make the server name field 176 end on a 32-bit boundary it may contain a padding field 194, filled with zeros. The server IP address field 178 contains all zeros in a remote access request message. In a remote access response message, the server IP address field 178 contains either the IP address of the server device, or, more often, the IP address of the preceding gateway device. The second variable-length part 162 in the remote access message section 156 contains a session specification, which for the current version of the remote access protocol consists of a number of client device and server device port number pairs. The actual number of pairs is specified in the number of queries field 172 or the number of replies field 174 described above.

FIG. 17 shows the format of a single port number pair 200 as contained in the session specification field 162. This format consists of a 2-byte client device port number field 202 and a 2-byte server device port number field 204. In the case that a server device does not allow or support the use of a port number present in the server device port number field 204, the server device will set the contents of this field to all zeros in a remote access response message. Future versions of the remote access protocol may include other types of session specifications.

FIG. 18 shows a block diagram of a simplified version of the client device 10. The client device 10 has a first output 210 connected to the public network 12 for sending data packets, such as, for example, the remote access request message 20, and a first input 212 also connected to the public network 12 for receiving data packets, such as, for example, the remote access response message 26. The directions in which the data packets travel are indicated by arrows. The first output 210 and the first input 212 are both connected to a control unit 214, controlling the operation of the client device 10.

FIG. 19 shows a block diagram of a simplified version of the server device 14. The server device 14 has a first input 220 connected to the private network 16 for receiving data packets, such as, for example, the remote access request message 22, and a first output 222 also connected to the private network 16 for sending data packets, such as, for example, the remote access response message 24. The directions in which the data packets travel are indicated by arrows. The first input 220 and the first output 222 are both connected to a control unit 224, controlling the operation of the server device 14.

It will be clear to those skilled in the art that a further extension which involves a single device that, for different remote access requests, can act as both a client device and a server device at the same time is also possible.

The different units in the gateway device 18 are normally provided in the form of one or more processors together with a program memory containing appropriate program code for performing the method according to the invention. The binding table 44 is also normally provided in the form of memory. The software or program code can also be provided on a computer program product in the form of a computer-readable medium, which will perform the method according to the invention when loaded into the gateway device 18, which is in fact a sort of computer. One such computer-readable medium in the form of a CD-ROM 230 is shown in FIG. 20, although there are other mediums possible such as diskettes. The program code can also be downloaded remotely from a server device outside the private network. It will be clear to those skilled in the art that a similar situation with respect to the appropriate program code for performing the method according to the invention exists for the client device 10 and the server device 14.

The invention can be summarized as follows.

A method is provided for providing a possibility of starting a communication session from a public or global data network, such as the Internet, to a private or local data network, such as a residential home network, via a gateway device (18) connecting the public and the private network. The gateway device comprises a Network Address Translation (NAT) functionality, concealing for the public network the addressing realm of the private network, but also customarily blocking the starting of sessions from the public network. According to the method provided, a client device (10) connected to the public network can provide the possibility of starting a session to a server device (14) connected to the private network by performing an explicit remote access request directed toward the server device, involving the exchange of remote access request messages (20, 22) between the client, gateway, and server devices. At the server device, the request triggers a related remote access response directed at the client device, similarly involving the exchange of remote access response messages (24, 26) between the devices. As a result of these message exchanges, an appropriate NAT address binding can be established at the gateway device, allowing the subsequent starting of a session by the client device.

1. A method of providing a possibility of starting a communication session from a first device (10) communicating via a first network (12) to a second device (14) connected to a second network (16), via an interface device (18) connected between the first network and the second network, wherein the first network has a first addressing realm and the second network has a second addressing realm, and wherein the first device communicates via a first address (Ac) in the first addressing realm, the second device has a second address (As) in the second addressing realm, and the interface device has a third address (Ag) in the first addressing realm, characterized in that the method comprises the following steps:
the interface device receives a request (20) from the first device to provide the possibility of starting the session, the request including a designation (60) of the second device and a session specification (62, 64),
determining a response for providing the possibility of starting the session,
the interface device establishes a binding (94) for starting the session, the binding comprising binding the first address to the second address for the session specified, and
the interface device adapts the response to include the third address and sends the response (26) to the first device.

2. A method as claimed in claim 1, wherein the step of determining a response comprises the following steps:
the interface device sends the request (22) to the second device,
the second device receives the request,
the second device prepares the response,
the second device sends the response (24) to the interface device, and
the interface device receives the response.

3. A method as claimed in claim 1, wherein the step of determining a response comprises the following steps:
the interface device sends the request (22) to the second device, and
the interface device, upon not receiving an answer from the second device within a predetermined time interval after sending the request, prepares the response.

4. A method as claimed in claim 1, 2, or 3, wherein the session specification comprises a first port number (Pc) related to the first address and a second port number (Ps) related to a service, the method further comprising the steps of:
binding the first and second port numbers to the already bound first and second addresses, and
associating the second port number with the third address.

5. A method as claimed in claim 1, 2, or 3, wherein the session specification comprises a first port number (Pc) related to the first address and a designation of a service, the method further comprising the steps of:
determining a second port number (Ps) related to the service,
binding the first and second port numbers to the already bound first and second addresses,
associating the second port number with the third address, and
including the second port number in the response.

6. An interface device (18) for connection between a first network (12) and a second network (16), the interface device providing a possibility of starting a communication session from a first device (10) communicating via the first network to a second device (14) connected to the second network, via the interface device, where the first network has a first addressing realm and the second network has a second addressing realm, and where the first device communicates via a first address (Ac) in the first addressing realm, the second device has a second address (As) in the second addressing realm, and the interface device has a third address (Ag) in the first addressing realm, characterized in that the interface device comprises:
a first input (30) for connection to the first network, for receiving a request (20) from the first device to provide the possibility of starting the session, the request including a designation (60) of the second device and a session specification (62, 64),
a first output (32) for connection to the first network, for sending a response (26) to the first device,
a binding table (44), and
a control unit (42) arranged to:
receive the request from the first input,
determine the response for providing the possibility of starting the session,
bind the first address to the second address for the session specified and store the result (94) in the binding table, and
adapt the response to include the third address and send the response from the first output.

7. An interface device as claimed in claim 6, further comprising:
a second output (34) for connection to the second network, for sending the request (22) to the second device,
a second input (36) for connection to the second network, for receiving the response (24) from the second device,
with the control unit arranged to:
send the request from the second output, and
receive the response from the second input.

8. An interface device as claimed in claim 6, further comprising:
a second output (34) for connection to the second network, for sending the request (22) to the second device,
a second input (36) for connection to the second network, for receiving the response (24) from the second device,
with the control unit arranged to:
send the request from the second output, and
upon not receiving an answer from the second device within a predetermined time interval after sending the request, prepare the response.

9. A first device (10) for connection to a first network (12), the first device providing a possibility of starting a communication session from the first device to a second device (14), via the first network, where the first network has a first addressing realm, characterized in that the first device comprises:
a first output (210) for connection to the first network, for sending a request (20) toward the second device to provide the possibility of starting the session, the request including a designation (60) of the second device and a session specification (62, 64),
a first input (212) for connection to the first network, for receiving a response (26), the response including a third address (Ag) in the first addressing realm via which to start the session, and
a control unit (214) arranged to:
prepare the request,
send the request from the first output, and
receive the response from the first input.

10. A second device (14) for connection to a second network (16), the second device providing a possibility of starting a communication session from a first device (10) to the second device, via the second network, where the second network has a second addressing realm, and the second device has a second address (As) in the second addressing realm, characterized in that the second device comprises:
a first input (220) for connection to the second network, for receiving a request (22) originating from the first device to provide the possibility of starting the session, the request including a designation (60) of the second device and a session specification (62, 64),
a first output (222) for connection to the second network, for sending a response (24) toward the first device, the response including the second address, and
a control unit (224) arranged to:
receive the request from the first input,
prepare the response, and
send the response from the first output.

11. A computer program product comprising a computer readable medium (230) to be used on a computer (18) connected between a first network (12) and a second network (16), the computer providing a possibility of starting a communication session from a first device (10) communicating via the first network to a second device (14) connected to the second network, via the computer, where the first network has a first addressing realm and the second network has a second addressing realm, and where the first device communicates via a first address (Ac) in the first addressing realm, the second device has a second address (As) in the second addressing realm, and the computer has a third address (Ag) in the first addressing realm, characterized in that the computer readable medium having thereon:
computer program code means, for making the computer execute, when the program code is loaded in the computer:
receiving a request (20) from the first device to provide the possibility of starting the session, the request including a designation (60) of the second device and a session specification (62, 64),
determining a response for providing the possibility of starting the session,
establishing a binding (94) for starting the session, the binding comprising binding the first address to the second address for the session specified, and
adapting the response to include the third address and sending the response (26) to the first device.

12. A computer program product comprising a computer readable medium (230) to be used on a computer (10) connected to a first network (12), the computer providing a possibility of starting a communication session from the computer to a second device (14), via the first network, where the first network has a first addressing realm, characterized in that the computer readable medium having thereon:
computer program code means, for making the computer execute, when the program code is loaded in the computer:
preparing a request to provide the possibility of starting the session, the request including a designation (60) of the second device and a session specification (62, 64),
sending the request (20) toward the second device, and
receiving a response (26), the response including a third address (Ag) in the first addressing realm via which to start the session.

13. A computer program product comprising a computer readable medium (230) to be used on a computer (14) connected to a second network (16), the computer providing a possibility of starting a communication session from a first device (10) to the computer, via the second network, where the second network has a second addressing realm, and the computer has a second address (As) in the second addressing realm, characterized in that the computer readable medium having thereon:
computer program code means, for making the computer execute, when the program code is loaded in the computer:
receiving a request (22) originating from the first device to provide the possibility of starting the session, the request including a designation (60) of the computer and a session specification (62, 64),
preparing a response, the response including the second address, and
sending the response (24) toward the first device.
